(19) United States
(12) Patent Application Publication
(10) Pub. No.: US 2021/0267342 A1
(43) Pub. Date: Sep. 2, 2021

(54) METAL HAIR DRYER WITH ADJUSTABLE AIR VOLUME

(71) Applicant: YUYAO HENGZHENG METALWARE CO., LTD., ZHEJIANG (CN)

(72) Inventor: Chaoqiang Zhou, Hunan (CN)

(21) Appl. No.: 16/972,523

(22) PCT Filed: Apr. 12, 2019
(86) PCT No.: PCT/CN2019/082520

§ 371 Date: Dec. 4, 2020

(30) Foreign Application Priority Data
Jun. 6, 2018 (CN) 201810586618.9

(51) Int. Cl. A45D 20/12; G06T 7/11; G06T 7/194

(52) U.S. Cl. CPC A45D 20/12; G06T 7/136; G06T 7/194; G06T 7/11

(57) ABSTRACT

The present invention relates to a metal hair dryer with an adjustable air volume. The hair dryer comprises: an air-blocking plate is used for adjusting the air intake volume of the hair dryer; a field data extraction device comprising an infrared transmitter, an infrared receiver, an ARM11 processor and an extraction controller, wherein the infrared transmitter is located on a data collection device and is used for vertically transmitting an infrared signal downwards, and the infrared receiver is located beside the infrared transmitter and is used for receiving the infrared signal, which is reflected back; and an air-blocking plate driving device is used for enabling an operation on the air-blocking plate when the human body detection device determines that there is a human body. By means of the present invention, an effective authentication mechanism is introduced for the hair dryer.

### TECHNICAL FIELD

The present invention relates to the field of household equipment, in particular to a metal hair dryer with an adjustable air volume.

### BACKGROUND ART

A hair dryer relies directly on a motor to drive the rotor, which in turn drives the fan blades to rotate. When the fan blades rotate, air is sucked in from the air inlet, and the resulting centrifugal airflow is blown out from the front nozzle of the hair dryer. When the air passes through, if the heating wire on the heating bracket installed in the tuyere has been energized to become hot, hot air will be blown out. If the selector switch does not make the heating wire energize and heat up, cold air will be blown out. A hair dryer is thus used to achieve the purpose of drying and shaping.

### SUMMARY OF THE INVENTION

In order to solve the technical problem of lacking an authentication mechanism for hair dryers in the prior art, the present invention provides a metal hair dryer with adjustable air volume, which introduces an air-blocking plate driving device. When the human body detection device determines that there is a human body, it enables the operation of the air-blocking plate and realizes the adjustment of air volume of the hair dryer, and when the human body detection device determines that no human body is presence, the operation of the air-blocking plate is prohibited, wherein the image is subjected to homomorphic filtering processing and histogram equalization processing, and threshold adjustment of each sub-image of image segmentation to further reduce the scope of image recognition and reduce the amount of data for subsequent image processing. Basing on the distribution of edge points in the image, different regions of the image are contrasted with different amplitudes to facilitate all kinds of subsequent image processing. Based on the results of infrared detection, the position controller is used to perform automatic reset of the data collection device, thereby avoiding excessive manual operations.

According to one aspect of the present invention, a metal hair dryer with an adjustable air volume is provided. The hair drier comprises: An air-blocking plate that is arranged at an air inlet of the hair dryer, is of a circular structure and is used for adjusting the air intake volume of the hair dryer.

More specifically, the metal hair dryer with an adjustable air volume further comprises: A field data extraction device comprising an infrared transmitter, an infrared receiver, an ARM11 processor and an extraction controller, wherein the infrared transmitter is located on a data collection device and is used for vertically transmitting an infrared signal downwards, the infrared receiver is located beside the infrared transmitter and is used for receiving the infrared signal, which is reflected back, the ARM11 processor is respectively connected to the infrared transmitter and the infrared receiver and is used for determining the real-time vertical position of the data collection device based on the transmission time of the infrared transmitter and the reception time of the infrared receiver, and the extraction controller is connected to the ARM11 processor and is used for sending a first extraction control signal when the real-time vertical position deviates from a preset vertical position and exceeds the limit; wherein, the extraction controller is further used for sending a second extraction control signal when the real-time vertical position deviates from a preset vertical position and does not exceed the limit.

More specifically, the metal hair dryer with an adjustable air volume further comprises: A data collection device, that is set at an air inlet of the hair dryer to collect image data of the scene where the hair dryer is located to output the corresponding scene image of the hair dryer.

More specifically, the metal hair dryer with an adjustable air volume further comprises: A background image processing device, which is respectively connected to the extraction controller and the data collection device, and is used for performing background extraction on the hair dryer scene image to obtain a real-time background image when the first extraction control signal is received, and matches the real-time background image with a preset background image to send a matching failure signal when the matching degree is less than a preset percentage threshold, and is also used for sending a matching success signal when the matching degree is greater than or equal to the preset percentage threshold, and it is also used for stopping the background extraction of scene image of the hair dryer when the second extraction control signal is received, and sends a matching success signal; a homomorphic filtering device, which is connected to the data collection device and is used for receiving the hair dryer scene image, and performs homomorphic filtering processing on the hair dryer scene image to obtain a corresponding homomorphic filtered image, wherein the greater the noise amplitude of the hair dryer scene image, the greater the intensity of the homomorphic filtering process; an equalization processing device, which is connected to the homomorphic filtering device, and is used for receiving the homomorphic filtered image, and performs histogram equalization processing on the homomorphic filtered image to obtain a corresponding histogram equalized image; a first threshold extraction device, which is connected to the equalization processing device, and is used for receiving the histogram equalized image, and determines the overall segmentation threshold corresponding to the histogram equalized image based on the distribution of the pixel value of each pixel in the histogram equalized image; a first parameter analysis device, which is used for receiving the histogram equalized image, and performs contrast analysis on the histogram equalized image to obtain and output the corresponding contrast; a first segmentation processing device, which is connected to the first parameter analysis device, and is used for receiving the contrast, and performs image segmentation processing on the histogram equalized image based on the contrast, to obtain multiple sub-images, wherein, the higher the contrast, the more sub-images can be obtained; a second threshold extraction device, which is connected to the first segmentation processing device, and is used for receiving the multiple sub-images, and determines the region segmentation threshold corresponding to the sub-images based on the distribution of the pixel value of each pixel in each sub-image, and output the segmentation threshold of each region corresponding to each sub-image; a first numerical adjustment device, which is respectively connected to the second threshold extraction device and the first threshold extraction device, and is used for receiving the overall segmentation threshold and each region segmentation threshold, and performs numerical adjustment on each region segmentation threshold based on the overall segmentation threshold, to obtain the adjusted region segmentation threshold and outputs as region adjusted threshold; in the first numerical adjustment device, performs the numerical adjustment of each region segmentation threshold based on the overall segmentation threshold includes: performs the numerical adjustment of the region segmentation threshold based on the difference between the overall segmentation threshold and each region segmentation threshold; in the first numerical adjustment device, performs the numerical adjustment of the region segmentation threshold based on the difference between the overall segmentation threshold and each region segmentation threshold includes: the adjusted region segmentation threshold is the sum of the region segmentation threshold and a quarter of the difference; a second segmentation processing device, which is connected to the first numerical adjustment device, and is used for segmenting the region adjustment threshold corresponding to each sub-image to obtain the corresponding target sub-image, and combining all the target sub-images to obtain and output the combined image; a distribution recognition device, which is connected to the second segmentation processing device, and is used for receiving the combined image, and performs edge point recognition on the combined image to obtain each edge point in the combined image, and for performing region segmentation on the combined image to obtain each region to be processed, and determining the number of edge points in each region to be processed; an intelligent enhancement device, which is connected to the distribution recognition device, and is used for receiving the number of edge points in each region to be processed, and uses the region to be processed where the number of edge points exceeds a preset number threshold as a region to be enhanced, and uses the region to be processed where the number of edge points does not exceed the preset number threshold as other region; a targeted enhancement device, which is respectively connected with the distribution recognition device and the intelligent enhancement device, performs corresponding amplitude of contrast enhancement processing based on the number of internal edge points of the region to be enhanced to obtain the processed enhancement region, and performs contrast enhancement processing of the same amplitude on other region to obtain other processed region; an image fitting device, which is connected to the targeted enhancement device, and is used for performing fitting processing on each processed enhancement region and each processed other region to obtain a corresponding fitting processed image, and outputs the fitting processed image; a background image update device, which is connected to the image fitting device, and is used for creating an initial value of the background image, and receives each fitting processed image in time order, wherein each time the fitting processed image is received, the previously determined background image is used to update the newly received fitting processed image; a human body detection device, which is connected to the background image update device, and is used for deleting the background image determined by the background image update device from the currently received fitting processed image to obtain a foreground image, and performs human body recognition in the foreground image to determine whether there is a human body; an air-blocking plate driving device, which is respectively connected to the human body detection device and the air-blocking device, and is used for enabling an operation on the air-blocking plate when the human body detection device determines that there is a human body.

More specifically, in the metal hair dryer with an adjustable air volume: the air-blocking plate driving device is further used for prohibiting the operation of the air-blocking plate when the human body detection device determines that there is no human body.

More specifically, in the metal hair dryer with an adjustable air volume: the human body detection device performs human body recognition in the foreground image to determine whether there is a human body, includes: determining whether to send a human body presence signal according to a result of performing human body recognition in the foreground image.

More specifically, in the metal hair dryer with an adjustable air volume: the amplitude of the contrast enhancement processing performed on each region to be enhanced is greater than the same amplitude.

More specifically, in the metal hair dryer with an adjustable air volume: the data collection device further includes a position controller, which is connected to the background image processing device, and is used for resetting the vertical position of the data collection device when the matching failure signal is received, so as to restore the real-time vertical position of the data collection device to the preset vertical position, and is also used for stopping the reset of vertical position of the data collection device when the matching success signal is received.

### DESCRIPTION OF ACCOMPANIED FIGURES

The embodiments of the present invention will be described below with reference to the accompanying figure, wherein:

FIG. 1 is a structural diagram of the metal hair dryer with adjustable air volume according to an embodiment of the present invention.

### DETAILED IMPLEMENTATION METHOD

Hereinafter, the embodiments of the metal hair dryer with adjustable air volume of the present invention will be described in detail with reference to the accompanying figure.

The selector switch on the handle of the hair dryer is generally divided into three, namely, off, cold wind and hot wind, with indicators in white, blue, and red. Some hair dryers are also equipped with a motor speed control switch on the handle for selecting the size of air volume and the temperature of hot air. All kinds of hair dryers are equipped with a rotatable circular air-regulating hood behind or beside the housing. Rotating the hood to adjust the cross-sectional size of the air inlet can adjust the conveying wind speed and the temperature of the hot air.

In order to overcome the above shortcomings, the present invention builds a metal hair dryer with adjustable air volume, which can effectively solve the corresponding technical problems.

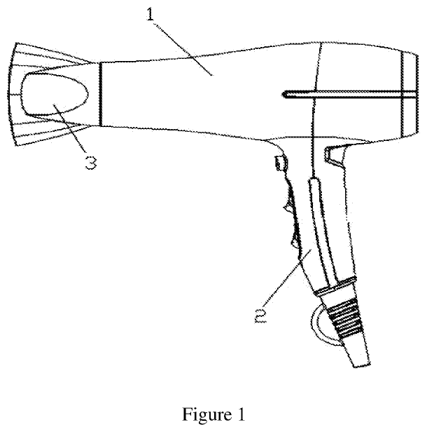

FIG. 1 is a schematic structural diagram of a metal hair dryer with adjustable air volume according to an embodiment of the present invention. The hair dryer includes a body 1, a handle 2 and a blowing port 3. The hair dryer further comprises:

an air-blocking plate that is arranged at an air inlet of the hair dryer, is of a circular structure and is used for adjusting the air intake volume of the hair dryer.

Next, the specific structure of the metal hair dryer with adjustable air volume of the present invention will be further described.

The metal hair dryer with adjustable air volume further comprises: A field data extraction device comprising an infrared transmitter, an infrared receiver, an ARM11 processor and an extraction controller, wherein the infrared transmitter is located on a data collection device and is used for vertically transmitting an infrared signal downwards, the infrared receiver is located beside the infrared transmitter and is used for receiving the infrared signal, which is reflected back, the ARM11 processor is respectively connected to the infrared transmitter and the infrared receiver and is used for determining the real-time vertical position of the data collection device based on the transmission time of the infrared transmitter and the reception time of the infrared receiver, and the extraction controller is connected to the ARM11 processor and is used for sending a first extraction control signal when the real-time vertical position deviates from a preset vertical position and exceeds the limit;

wherein, the extraction controller is further used for sending a second extraction control signal when the real-time vertical position deviates from a preset vertical position and does not exceed the limit.

The metal hair dryer with an adjustable air volume further comprises: A data collection device, that is set at an air inlet of the hair dryer to collect image data of the scene where the hair dryer is located to output the corresponding scene image of the hair dryer.

The metal hair dryer with an adjustable air volume further comprises: A background image processing device, which is respectively connected to the extraction controller and the data collection device, and is used for performing background extraction on the hair dryer scene image to obtain a real-time background image when the first extraction control signal is received, and matches the real-time background image with a preset background image to send a matching failure signal when the matching degree is less than a preset percentage threshold, and is also used for sending a matching success signal when the matching degree is greater than or equal to the preset percentage threshold, and it is also used for stopping the background extraction of scene image of the hair dryer when the second extraction control signal is received, and sends a matching success signal;

a homomorphic filtering device, which is connected to the data collection device and is used for receiving the hair dryer scene image, and performs homomorphic filtering processing on the hair dryer scene image to obtain a corresponding homomorphic filtered image, wherein the greater the noise amplitude of the hair dryer scene image, the greater the intensity of the homomorphic filtering process;
an equalization processing device, which is connected to the homomorphic filtering device, and is used for receiving the homomorphic filtered image, and performs histogram equalization processing on the homomorphic filtered image to obtain a corresponding histogram equalized image;
a first threshold extraction device, which is connected to the equalization processing device, and is used for receiving the histogram equalized image, and determines the overall segmentation threshold corresponding to the histogram equalized image based on the distribution of the pixel value of each pixel in the histogram equalized image;
a first parameter analysis device, which is used for receiving the histogram equalized image, and performs contrast analysis on the histogram equalized image to obtain and output the corresponding contrast;
a first segmentation processing device, which is connected to the first parameter analysis device, and is used for receiving the contrast, and performs image segmentation processing on the histogram equalized image based on the contrast, to obtain multiple sub-images, wherein, the higher the contrast, the more sub-images can be obtained;
a second threshold extraction device, which is connected to the first segmentation processing device, and is used for receiving the multiple sub-images, and determines the region segmentation threshold corresponding to the sub-images based on the distribution of the pixel value of each pixel in each sub-image, and output the segmentation threshold of each region corresponding to each sub-image; a first numerical adjustment device, which is respectively connected to the second threshold extraction device and the first threshold extraction device, and is used for receiving the overall segmentation threshold and each region segmentation threshold, and performs numerical adjustment on each region segmentation threshold based on the overall segmentation threshold, to obtain the adjusted region segmentation threshold and outputs as region adjusted threshold; in the first numerical adjustment device, performs the numerical adjustment of each region segmentation threshold based on the overall segmentation threshold includes: performs the numerical adjustment of the region segmentation threshold based on the difference between the overall segmentation threshold and each region segmentation threshold; in the first numerical adjustment device, performs the numerical adjustment of the region segmentation threshold based on the difference between the overall segmentation threshold and each region segmentation threshold includes: the adjusted region segmentation threshold is the sum of the region segmentation threshold and a quarter of the difference;
a second segmentation processing device, which is connected to the first numerical adjustment device, and is used for segmenting the region adjustment threshold corresponding to each sub-image to obtain the corresponding target sub-image, and combining all the target sub-images to obtain and output the combined image;
a distribution recognition device, which is connected to the second segmentation processing device, and is used for receiving the combined image, and performs edge point recognition on the combined image to obtain each edge point in the combined image, and for performing region segmentation on the combined image to obtain each region to be processed, and determining the number of edge points in each region to be processed;
an intelligent enhancement device, which is connected to the distribution recognition device, and is used for receiving the number of edge points in each region to be processed, and uses the region to be processed where the number of edge points exceeds a preset number threshold as a region to be enhanced, and uses the region to be processed where the number of edge points does not exceed the preset number threshold as other region;
a targeted enhancement device, which is respectively connected with the distribution recognition device and the intelligent enhancement device, performs corresponding amplitude of contrast enhancement processing based on the number of internal edge points of the region to be enhanced to obtain the processed enhancement region, and performs contrast enhancement processing of the same amplitude on other region to obtain other processed region;
an image fitting device, which is connected to the targeted enhancement device, and is used for performing fitting processing on each processed enhancement region and each processed other region to obtain a corresponding fitting processed image, and outputs the fitting processed image; a background image update device, which is connected to the image fitting device, and is used for creating an initial value of the background image, and receives each fitting processed image in time order, wherein each time the fitting processed image is received, the previously determined background image is used to update the newly received fitting processed image;
a human body detection device, which is connected to the background image update device, and is used for deleting the background image determined by the background image update device from the currently received fitting processed image to obtain a foreground image, and performs human body recognition in the foreground image to determine whether there is a human body; an air-blocking plate driving device, which is respectively connected to the human body detection device and the air-blocking device, and is used for enabling an operation on the air-blocking plate when the human body detection device determines that there is a human body.

In the metal hair dryer with an adjustable air volume: the air-blocking plate driving device is further used for prohibiting the operation of the air-blocking plate when the human body detection device determines that there is no human body.

In the metal hair dryer with an adjustable air volume: the human body detection device performs human body recognition in the foreground image to determine whether there is a human body, includes: determining whether to send a human body presence signal according to a result of performing human body recognition in the foreground image.

In the metal hair dryer with an adjustable air volume: the amplitude of the contrast enhancement processing performed on each region to be enhanced is greater than the same amplitude.

And, in the metal hair dryer with an adjustable air volume: the data collection device further includes a position controller, which is connected to the background image processing device, and is used for resetting the vertical position of the data collection device when the matching failure signal is received, so as to restore the real-time vertical position of the data collection device to the preset vertical position, and is also used for stopping the reset of vertical position of the data collection device when the matching success signal is received.

In addition, the image filtering performed by the homomorphic filtering device suppresses the noise of the target image while preserving the details of the image as much as possible, which is an indispensable operation in image preprocessing, and the quality of its processing effect will directly affect the validity and reliability of subsequent image processing and analysis.

Due to the imperfections of imaging systems, transmission media and recording equipment, digital images are often contaminated by various noises during their formation, transmission and recording process. In addition, in some aspects of image processing, when the input image object is not as expected, noise will be introduced into the result image. These noises often appear on the image as an isolated pixel or pixel block that causes a relatively strong visual effect. Generally, the noise signal is not related to the object to be studied, and appears in the form of useless information, disturbing the observable information of the image. For digital image signals, the noise is a large or small extreme value. These extreme values act on the true gray value of image pixels through addition and subtraction, causing interference of bright and dark spots on the image, greatly reducing image quality and affecting follow-up work such as image restoration, segmentation, feature extraction, and image recognition. To construct a filter that effectively suppresses noise, two basic issues must be considered: it can effectively remove the noise in the target and background; and, at the same time, it can well protect the shape, size and specific geometric and topological features of the image target.

One of the commonly used image filtering modes is the non-linear filter. Generally speaking, when the signal spectrum and the noise spectrum are aliased or when the signal contains non-superimposed noise, such as the noise caused by the system nonlinearity or the presence of non-linearity Gaussian noise, etc., traditional linear filtering techniques, such as Fourier transform, while filtering noise, always blur the image details (such as edges, etc.) in some way, resulting in decrease of positioning accuracy of linear features and the extraction of features. The nonlinear filter is based on a nonlinear mapping relationship to the input signal. It can often map a specific noise approximately to zero while retaining the important characteristics of the signal, so it can overcome the shortcomings of linear filter to a certain extent.

Using the metal hair dryer with adjustable air volume of the present invention, in response to the technical problem of the imperfect authentication mechanism of hair dryers in the prior art, by introducing an air-blocking plate driving device, when the human body detection device determines that there is a human body, the air-blocking plate operates to achieve the adjustment of the air volume of the hair dryer, and prohibit the operation of the air-blocking plate when the human body detection device determines that there is no human body, wherein the image is subjected to homomorphic filtering processing, histogram equalization processing and image segmentation, and threshold adjustment of each sub-image of the segmented image further reduces the scope of image recognition and reduces the amount of data for subsequent image processing. Different areas of the image are contrasted with different amplitudes according to the distribution of edge points in the image to facilitate various subsequent image processing. Based on the results of infrared detection, the position controller is used to perform automatic resetting of the data acquisition device, avoiding excessive manual operations, thereby solving the above technical problems.

It can be understood that although the present invention has been disclosed as above in preferred embodiments, the above-mentioned embodiments are not intended to limit the present invention. For any person skilled in the art, the technical content disclosed above can be used to make many possible changes and amendments to the technical solution of the present invention, or modified into equivalent changes, etc. with similar efficacies without departing from the scope of the technical solution of the present invention. Therefore, any simple modifications, equivalent changes and amendments made to the above embodiments without departing from the technical solution of the present invention based on the technical essence of the present invention still fall within the protection scope of the technical solution of the present invention.

1-8. (canceled)

9. A metal hair dryer with an adjustable air volume, characterized by the hair dryer comprises:
an air-blocking plate that is arranged at an air inlet of the hair dryer, is of a circular structure and is used for adjusting the air intake volume of the hair dryer.
characterized by the hair dryer further comprises:
a field data extraction device comprising an infrared transmitter, an infrared receiver, an ARM11 processor and an extraction controller, wherein the infrared transmitter is located on a data collection device and is used for vertically transmitting an infrared signal downwards, the infrared receiver is located beside the infrared transmitter and is used for receiving the infrared signal, which is reflected back, the ARM11 processor is respectively connected to the infrared transmitter and the infrared receiver and is used for determining the real-time vertical position of the data collection device based on the transmission time of the infrared transmitter and the reception time of the infrared receiver, and the extraction controller is connected to the ARM11 processor and is used for sending a first extraction control signal when the real-time vertical position deviates from a preset vertical position and exceeds the limit;
wherein, the extraction controller is further used for sending a second extraction control signal when the real-time vertical position deviates from a preset vertical position and does not exceed the limit.
characterized by the hair dryer further comprises:
a data collection device, that is set at an air inlet of the hair dryer to collect image data of the scene where the hair dryer is located to output the corresponding scene image of the hair dryer.
characterized by the hair dryer further comprises:
a background image processing device, which is respectively connected to the extraction controller and the data collection device, and is used for performing background extraction on the hair dryer scene image to obtain a real-time background image when the first extraction control signal is received, and matches the real-time background image with a preset background image to send a matching failure signal when the matching degree is less than a preset percentage threshold, and is also used for sending a matching success signal when the matching degree is greater than or equal to the preset percentage threshold, and it is also used for stopping the background extraction of scene image of the hair dryer when the second extraction control signal is received, and sends a matching success signal;
a homomorphic filtering device, which is connected to the data collection device and is used for receiving the hair dryer scene image, and performs homomorphic filtering processing on the hair dryer scene image to obtain a corresponding homomorphic filtered image, wherein the greater the noise amplitude of the hair dryer scene image, the greater the intensity of the homomorphic filtering process;
an equalization processing device, which is connected to the homomorphic filtering device, and is used for receiving the homomorphic filtered image, and performs histogram equalization processing on the homomorphic filtered image to obtain a corresponding histogram equalized image;
a first threshold extraction device, which is connected to the equalization processing device, and is used for receiving the histogram equalized image, and determines the overall segmentation threshold corresponding to the histogram equalized image based on the distribution of the pixel value of each pixel in the histogram equalized image;
a first parameter analysis device, which is used for receiving the histogram equalized image, and performs contrast analysis on the histogram equalized image to obtain and output the corresponding contrast;
a first segmentation processing device, which is connected to the first parameter analysis device, and is used for receiving the contrast, and performs image segmentation processing on the histogram equalized image based on the contrast, to obtain multiple sub-images, wherein, the higher the contrast, the more sub-images can be obtained;
a second threshold extraction device, which is connected to the first segmentation processing device, and is used for receiving the multiple sub-images, and determines the region segmentation threshold corresponding to the sub-images based on the distribution of the pixel value of each pixel in each sub-image, and output the segmentation threshold of each region corresponding to each sub-image;
a first numerical adjustment device, which is respectively connected to the second threshold extraction device and the first threshold extraction device, and is used for receiving the overall segmentation threshold and each region segmentation threshold, and performs numerical adjustment on each region segmentation threshold based on the overall segmentation threshold, to obtain the adjusted region segmentation threshold and outputs as region adjusted threshold; in the first numerical adjustment device, performs the numerical adjustment of each region segmentation threshold based on the overall segmentation threshold includes: performs the numerical adjustment of the region segmentation threshold based on the difference between the overall segmentation threshold and each region segmentation threshold; in the first numerical adjustment device, performs the numerical adjustment of the region segmentation threshold based on the difference between the overall segmentation threshold and each region segmentation threshold includes: the adjusted region segmentation threshold is the sum of the region segmentation threshold and a quarter of the difference;
a second segmentation processing device, which is connected to the first numerical adjustment device, and is used for segmenting the region adjustment threshold corresponding to each sub-image to obtain the corresponding target sub-image, and combining all the target sub-images to obtain and output the combined image;
a distribution recognition device, which is connected to the second segmentation processing device, and is used for receiving the combined image, and performs edge point recognition on the combined image to obtain each edge point in the combined image, and for performing region segmentation on the combined image to obtain each region to be processed, and determining the number of edge points in each region to be processed;
an intelligent enhancement device, which is connected to the distribution recognition device, and is used for receiving the number of edge points in each region to be processed, and uses the region to be processed where the number of edge points exceeds a preset number threshold as a region to be enhanced, and uses the region to be processed where the number of edge points does not exceed the preset number threshold as other region;
a targeted enhancement device, which is respectively connected with the distribution recognition device and the intelligent enhancement device, performs corresponding amplitude of contrast enhancement processing based on the number of internal edge points of the region to be enhanced to obtain the processed enhancement region, and performs contrast enhancement processing of the same amplitude on other region to obtain other processed region;
an image fitting device, which is connected to the targeted enhancement device, and is used for performing fitting processing on each processed enhancement region and each processed other region to obtain a corresponding fitting processed image, and outputs the fitting processed image;
a background image update device, which is connected to the image fitting device, and is used for creating an initial value of the background image, and receives each fitting processed image in time order, wherein each time the fitting processed image is received, the previously determined background image is used to update the newly received fitting processed image;
a human body detection device, which is connected to the background image update device, and is used for deleting the background image determined by the background image update device from the currently received fitting processed image to obtain a foreground image, and performs human body recognition in the foreground image to determine whether there is a human body;
an air-blocking plate driving device, which is respectively connected to the human body detection device and the air-blocking device, and is used for enabling an operation on the air-blocking plate when the human body detection device determines that there is a human body.

10. A metal hair dryer with an adjustable air volume of claim 9, characterized by:
the air-blocking plate driving device is further used for prohibiting the operation of the air-blocking plate when the human body detection device determines that there is no human body.

11. A metal hair dryer with an adjustable air volume of claim 10, characterized by:
the human body detection device performs human body recognition in the foreground image to determine whether there is a human body, includes: determining whether to send a human body presence signal according to a result of performing human body recognition in the foreground image.

12. A metal hair dryer with an adjustable air volume of claim 11, characterized by:
the amplitude of the contrast enhancement processing performed on each region to be enhanced is greater than the same amplitude.

13. A metal hair dryer with an adjustable air volume of claim 12, characterized by:
the data collection device further includes a position controller, which is connected to the background image processing device, and is used for resetting the vertical position of the data collection device when the matching failure signal is received, so as to restore the real-time vertical position of the data collection device to the preset vertical position, and is also used for stopping the reset of vertical position of the data collection device when the matching success signal is received.
